(19) United States
(12) Patent Application Publication
(10) Pub. No.: US 2010/0101732 A1
(43) Pub. Date: Apr. 29, 2010

(54) METHOD AND APPARATUS FOR ESTABLISHING OBTAINABLE RANGE OF DIAMETERS OF A WORKING DRUM

(76) Inventors: Sean E. Howley, Maryville, TN (US); Clark A. Roberts, Maryville, TN (US)

Correspondence Address: PITTS AND BRITTIAN P C, P O BOX 51295, KNOXVILLE, TN, 37950-1295, US

(21) Appl. No.: 12/256,966

(22) Filed: Oct. 23, 2008

(51) Int. Cl. B29D 30/24; B23P 17/00; F16M 13/00

(52) U.S. Cl. 156/414; 29/592; 248/637

(57) ABSTRACT

Method and apparatus for establishing a range of diameters of the cylindrical working surface of a drum and like devices for grasping, handling, shaping, or other like function, of round or tubular objects, such as tire carcasses and belt and tread packages as employed in the manufacture of vehicle tires. The device includes a plurality of segmented modules adapted to be quickly and releasably manually affixed to a drum or like device in a manner which establishes the range of obtainable diameters of the cylindrical working surface of the existing device. No material structural and/or operational modifications in the basic elements and/or operation of the drum are required. Rather, the existing structural and operational aspects of the existing drum are employed in combination with the present invention.

### FIELD OF INVENTION

This invention relates to devices for grasping, handling, shaping, or other like function, of round or tubular objects, such as tire carcasses, belt and tread subassemblies employed in the motor vehicle tire making industry.

### BACKGROUND OF THE INVENTION

In the manufacture of vehicle tires, it is common that various subassemblies destined to become a part of a vehicle tire must be grasped, shaped, or otherwise handled, positioned, or otherwise moved from location to location, held stationary for limited time periods, and/or shaped. U.S. Pat. No. 5,635,016, entitled: Transfer Ring or Drum Apparatus with Adjustable Circumference, issued Jun. 4, 1997 (“the '016 patent”), the entirety of which is incorporated herein by reference, discloses a device of the type wherein the outer working surface of the device is adjustable between minimum and maximum diameter values. Most commonly, such devices include multiple elongated segments, each being of an arcuate cross-section. These segments are arrayed about a central axis to collectively define a cylindrical working surface of the device. By reason of their mechanical structure, the available operating space internally of the drum of these prior art devices commonly is limited as to the maximum and minimum diameters obtainable by the device. For this reason, when desiring to manufacture tires having a desired diameter outside the range of obtainable diameters with a given device (generically referred to herein at times as a “drum”), it is required to use a different drum having a greater or lesser obtainable maximum diameter of its cylindrical working surface. Additionally, such drums are sufficiently heavy as to require lifting by a crane or like lifting means. Exchanging drums is therefore time-consuming, results in undesirable down-time of the device during the changeover and otherwise costly. Commonly, there is required an expensive inventory of different diameter drums.

For reasons of clarity, herein the present invention is described as being employed with a drum of the type disclosed in the '016 patent. It will be recognized by one skilled in the art that the present invention is adaptable to other similar drums of the prior art, or even may incorporated into a newly designed drum as circumstances dictate.

Moreover, the present invention may be manufactured to establish the maximum/minimum range of diameters of a drum by selected increments, the maximum diameter developed being limited substantially only by the rigidity of the components of the drum and of the present invention. That is, the maximum obtainable diameter (i.e., cylindrical working surface) of a given drum may be selectively increased by several inches by means of the present invention. For example, employing the present invention, a drum having an original maximum diameter of 23 inches may be converted to a drum having a maximum diameter of 26 or more inches, all without material modification of the original operational elements of the preexisting drum.

### SUMMARY OF THE INVENTION

In accordance with one aspect of the present invention there is provided a method and apparatus for establishing a range of maximum diameters, hence the cylindrical of the working surface, of drums and like devices for grasping, handling, shaping, or other like function, of round or tubular objects, such as tire carcasses and belt and tread packages as employed in the manufacture of vehicle tires. The device includes a plurality of segmented subassemblies (modules) adapted to be quickly and releasably manually affixed to the existing drum or like device in a manner which establishes a range of obtainable diameters of the cylindrical working surface of the existing device. This action requires no material structural and/or operational modifications in the basic elements and/or operation of the original drum. Rather, the existing structural and operational aspects of the existing drum are employed in combination with the present invention. The present invention may be employed to establish a range of increased diameters of the cylindrical working surface of a drum having an existing “main deck. However, as desired, the present invention may be employed to define the “main deck” of the drum.

In one embodiment, the present invention includes a plurality of subassemblies, (modules) each of which is formed from a plurality of elongated segments having individual arcuate cross-sections. The segments of each module are oriented parallel to one another in side-by-side relationship and interconnected such that the module may be manipulated as a unitary subassembly in the course of the module being applied to or removed from a drum. In one embodiment, each module is releaseably affixed to an existing drum in a manner whereby the movement of the modules toward definition of a maximum outer diameter of the device is a function of the operational means employed by the existing drum. Quick release locking means is provided for releaseably securing the modules in their respective operative relationship to the existing device. The present invention, in one embodiment, therefore provides for the “addition” of a secondary deck (outer or inner circumferential working surface) concentrically of an existing main deck of the drum without tools and without altering the functionality of the drum so that later on the secondary deck may be removed and the drum can return to use of its main deck after the present modules have been removed from the drum. Through the use of the latchable modules of the present invention, the noted enhancement of the existing drum is obtainable while the drum is in place on a tire making machine and is thereby rotatable for serial application or removal of modules to or from the existing drum.

### BRIEF DESCRIPTION OF THE DRAWINGS

FIG. 1 is a schematic representation of a prior art drum depicted in its expanded attitude and which is useful in the manufacture of motor vehicle tires and further depicting one embodiment of modules of the present invention mounted on the drum;

FIG. 2A is an end view of the drum depicted in FIG. 1 depicted in its collapsed attitude;

FIG. 2B is an enlarged view of a cutway portion of the drum depicted in FIG. 2A taken generally along the line 2B-2B of FIG. 2A;

FIG. 3 is an inboard bottom view, in perspective, of a module for a secondary deck of the present invention;

FIG. 4 is an end view of the module depicted in FIG. 3;

FIG. 5A is a front view of one embodiment of a latch of the present invention;

FIG. 5B is a partially exploded view depicting the outboard (front) side of a latch of the present invention;

FIG. 5C is a further partially exploded view of the latch of FIG. 5A and depicting the inboard (rear) side of the latch;

FIG. 5D is a representation of one embodiment of a cutaway of a portion to latch depicted in FIG. 5A taken generally along the line 5D-5D of FIG. 5A;

FIG. 6 is an exploded view depicting the placement of a latching lever in one embodiment of the latch of the present invention;

FIG. 7 is a front side view of one embodiment of a latch of the present invention poised in its initial relationship to receive the latch in locking relationship therewith and to a latch lever disposed in the latch;

FIG. 8 is a front side view as depicted in FIG. 7 and with the latch partially engaging the receiver and depicting the disposition of the latch lever at the depicted stage of engagement of the latch and receiver;

FIG. 9 is a front side view as depicted in FIG. 7 and with the latch lever further engaging the receiver and depicting the disposition of the latch lever at the depicted stage of engagement of the latch and receiver;

FIG. 10 is a front side view as depicted in FIG. 7 and with the latch fully engaged with the receiver and depicting the locking disposition of the latch lever at the fully locked stage of engagement of the latch and receiver;

FIG. 11 is a front side view of a radial guide adapted to be mounted on one end of a lateral segment of a module of the present invention and depicting the relationship of such radial guide preparatory to the entry of a cam pin on the radial guide engaging the camming groove of a camming guide;

FIG. 12 is a front side view of the radial guide of FIG. 11 with its cam pin initially inserted into the camming groove of the camming guide;

FIG. 13 is a front side view of the radial guide of FIG. 11 with its cam pin substantially disposed within the camming groove of the camming guide member;

FIG. 14 is a front side view of the radial guide of FIG. 11 with its cam pin maximally disposed with the camming groove of the camming guide.

### DETAILED DESCRIPTION OF THE INVENTION

With respect to the prior art drum/transfer ring disclosed in the '016 patent, briefly, such drum/transfer ring disclosed in such patent is one type of drum with which the present invention is useful. As noted it will be recognized that the present invention is useful with other type drums and is not to be deemed as being limited to use with the “016 patent” drum/transfer ring.

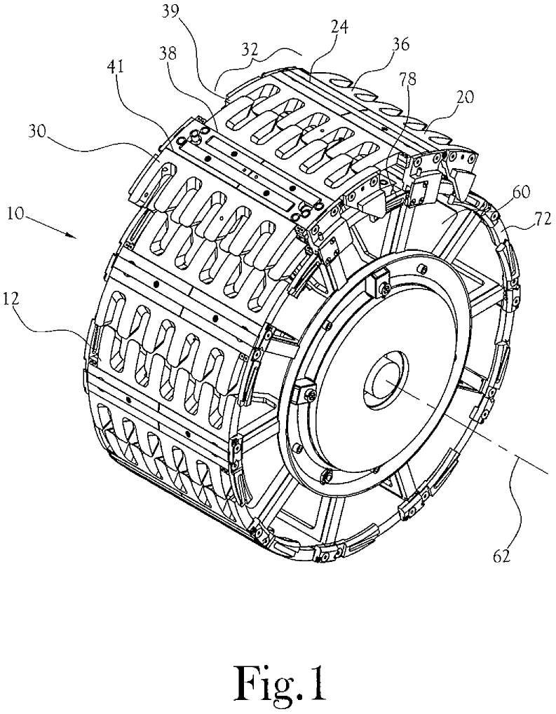

With present reference to FIG. 1 which depicts a drum of the “016 patent”. This drum of the “016 patent” is generally described as comprising, a mounting ring which serves to mount a plurality of multiple segments that collectively define a cylindrical working surface of the drum about a central axis 62 thereof. Such drum is useful as a cylindrical working (forming) surface (as in the build up of a belt and tread package for a vehicle tire), or for use, in grasping the inner circumference or the outer circumference of a circular, tubular or round object (as in a transfer ring) and in which the multiple segments are each arcuate in cross section to cooperatively define a cylindrical working surface of the drum. Each grouping of segments includes an intermediate segment that is mounted for radial movement inwardly and outwardly, relative to the central axis of the apparatus, and flanking side segments that are hingedly mounted to the intermediate segment on the opposite elongated sides thereof for relative hinged movement with respect to the intermediate segment as the intermediate segment is moved radially of the drum, such that their composite cross sections closely approximate a true cylindrical working surface over a range of radial movement of the intermediate segment.

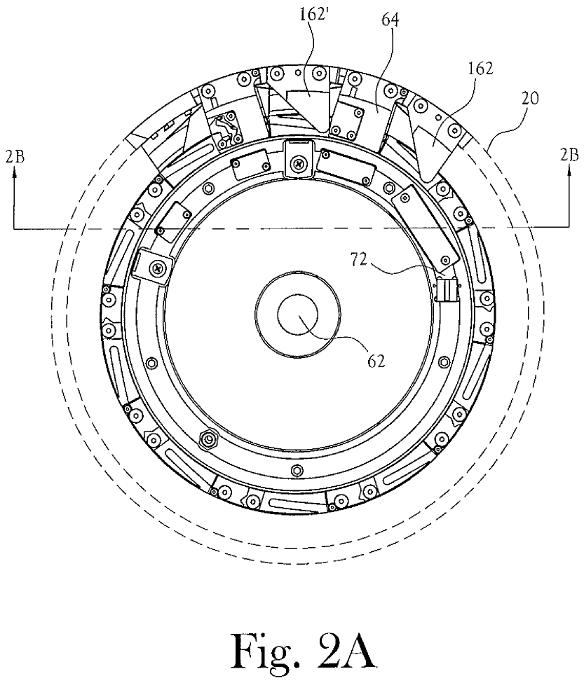

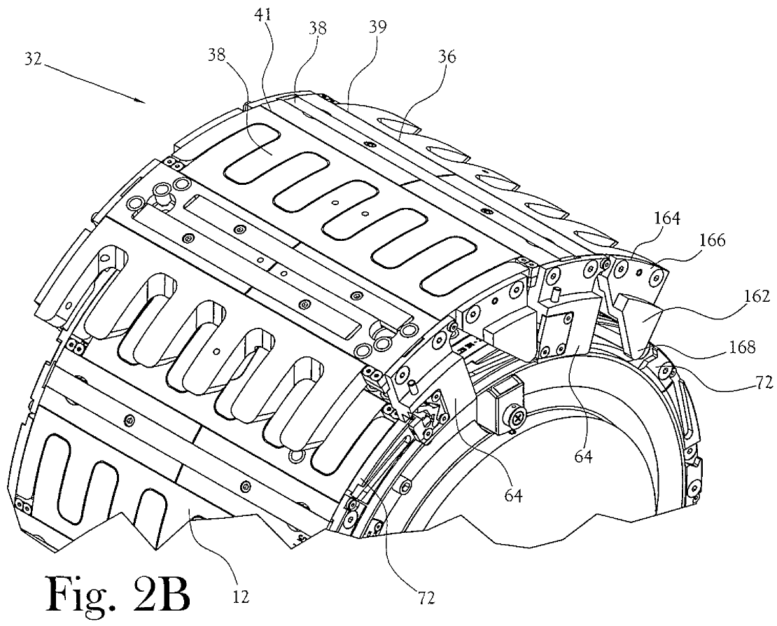

In FIG. 2A the drum is depicted in its cylindrically expanded attitude (maximum diameter).

In FIG. 1 this same drum is depicted in its retracted attitude (minimum diameter).

As depicted in FIGS. 1-3, in one embodiment, the present invention is useful in conjunction with a drum 10 (or transfer ring) that may incorporate a main deck 12 having the capability of moving multiple elongated segments of individual arcuate cross sections radially inwardly and outwardly of the drum to collectively define the cylindrical working surface of the drum. Herein this working surface is referred to as the main deck and may be a part of a drum as disclosed in the “016 patent”.

In one embodiment of the present invention, the drum 10 is provided with a secondary deck 30 comprising at least two, and commonly more, subassemblies, (modules) 32 each of which is formed from an elongated central segment 34 flanked on the opposite longitudinal sides 39, 41, thereof by respective longitudinal first and second elongated lateral segments 36 and 38, respectively, which are hinged along their respective longitudinal sides of the central segment. Each of these segments exhibits an arcuate cross-section. The segments of each module are oriented parallel to one another in side-by-side relationship and secured in a substantially rigid attitude with respect to the central segment such that the module may be manipulated as a unitary module 32 for purposes of application and removal of a module from the drum. That is, each module may be grasped by a user's hands at locations on the opposite ends 40, 42, of the module, lifted and moved about as a unit for purposes of mounting and dismounting of the module on an existing drum without the use of tools.

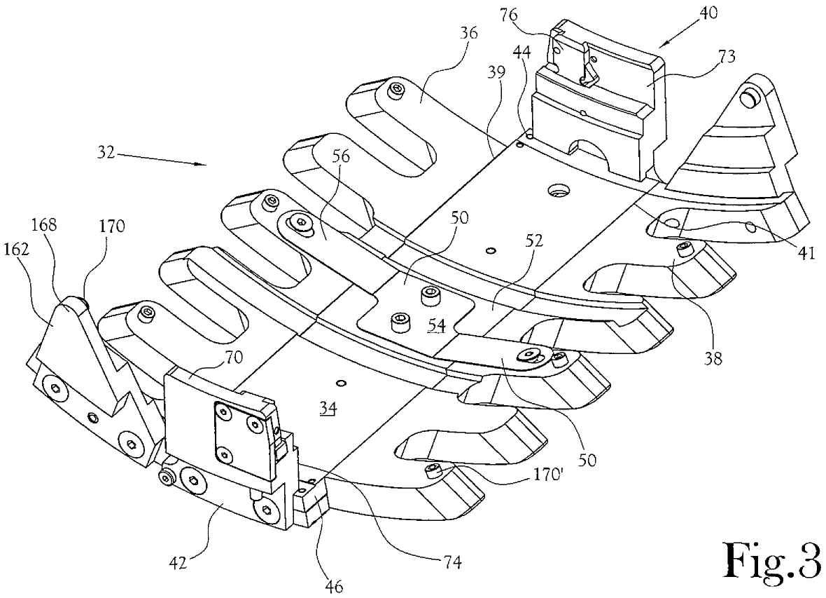

To secure the first and second segments in such substantially rigid attitude while providing for the required hinged relationship between the central segment and the first and second segments, the present invention provides a flat strip spring 50 disposed on the radially inboard side of each of the modules. As seen in FIG. 3 this spring includes a central body portion which is fixed to the inboard surface of the central segment and first and second opposite legs 56, 58 extending laterally from the central body portion 54. A first one 56 of these opposite legs overlies and is attached to the first segment 36 of the module and an opposite second leg 58 overlies and is attached to the second segment 38 of the module. As depicted in FIG. 3 the mounting of the spring on the radially inward concave surface 52 of the module functions to bias the first and second segments toward a position of concavity of the first and second segments relative to the central segment, while precluding material hinged movement of either of the first and second segments relative to the central segment when the module is not mounted on a drum. The resistance to bending of this strip spring is chosen to be sufficient to preclude the first and second segments from folding radially inwardly of the module when the module is lifted by grasping its opposite ends 40, 42 in the process of mounting of the module on the drum or removing the module from the drum. On the other hand, the spring readily bends as needed when the diameter of the module is changed in the course of the expansion and retraction of the modules during operation of the drum.

At least two modules are employed on a given drum to define the cylindrical working surface 20 of the secondary deck. More modules may be employed as desired so long as the total number of modules collectively defines the desired cylindrical working surface of the secondary deck of the drum. For example, when two modules are employed, each module defines a hemispherical working surface so that their combination defines a cylindrical working surface. In one embodiment, ten modules are employed for ease of handling of the modules as they are mounted on or removed from the drum.

Each module is releasably mounted in overlying, but spaced apart, relationship to the main deck of an existing drum in a manner whereby there is provided an annular space 60 (See FIG. 1) between the main deck and the secondary deck within which the modules of the secondary deck may be moved in the course of their radial movement when the diameter of the drum is reduced or increased during the functioning of the drum.

The movement of the modules toward or away from definition of a cylindrical working surface of the drum is a function of the existing operational means employed by the existing drum, such as the existing operational means employed in the drum disclosed in the “01638 patent”. Such operational means provides for radial movement of the segments of the main deck, with such movement of the segments of the main deck being substantially followed by the segments of the secondary deck. It will be recognized that the present invention positions the secondary deck radially further away from the central axis of the drum than the positions of the main deck so that minimum and maximum obtainable diameters employing the secondary deck is substantially enhanced over the minimum and maximum obtainable diameters of the preexisting drum and its main deck.

Referring to FIGS. 2, 3, 4 and 5A-10, mounting of each of the modules on the drum is accomplished by means of manually operable locking latches. In the depicted embodiment of the present invention, there is provided on each of the opposite ends 44, 46 of the central segment 34 a quick release latch 64 for releasably securing each of the multiple modules in operable relationship to the existing drum. In short, the present invention provides for the “addition” of a secondary deck (outer or inner circumferential working surface) onto an existing main drum without altering the functionality of the drum so that later on the modules of the secondary deck may be removed and the drum can return to use of its main deck after the present modules have been removed from the drum. Such mounting and dismounting of the modules is carried out manually, without the aid of tools.

In the depicted embodiment of the present invention, interconnection of each of the modules of the secondary deck with the existing drum is accomplished by first and second automatically locking latches 64, 64 each of which requires a deliberate action to unlock the latch. As seen in FIG. 3, one latch is mounted on each of the first and second opposite ends of each central segment of each module.

Referring specifically to FIGS. 1 and 3-6, one embodiment of a locking latch 64 of the present invention may comprise a latch housing 66 which may be of a planar rectangular geometry. The top end 68 of each latch housing is fixedly mounted to its respective end of a central segment 34 of a module and depends therefrom in cantilevered fashion radially inwardly of the drum to the extent that the bottom end 70 of the latch housing overlies the mounting ring 72 (see FIG. 2B) for the segments of the main deck 12 of the drum. On that inboard surface 73 (FIG. 3) of the housing which faces inwardly of the drum, there is provided a planar projection 76, in the nature of an elongated dove tail projection.

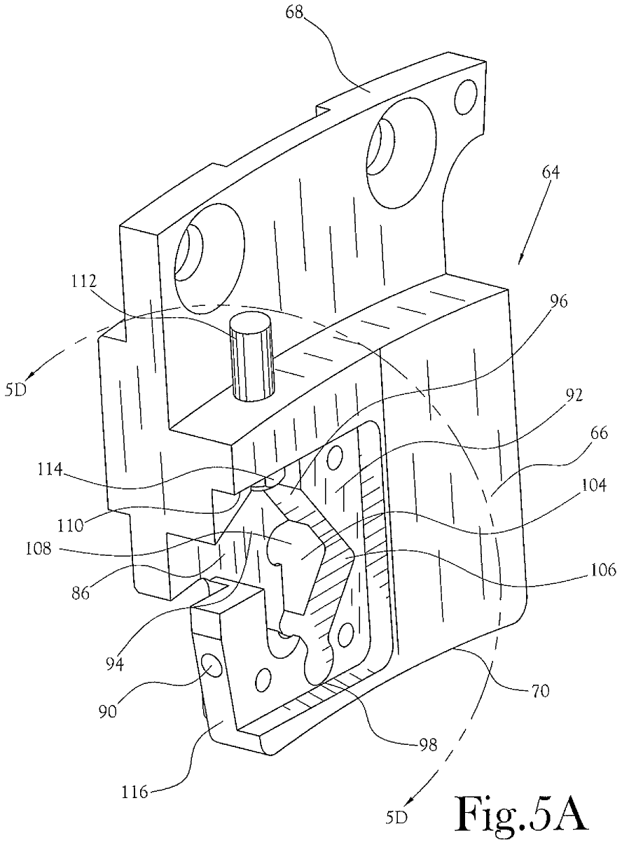

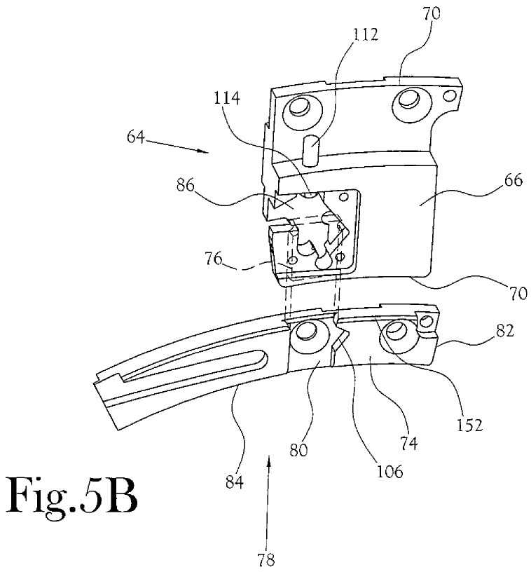

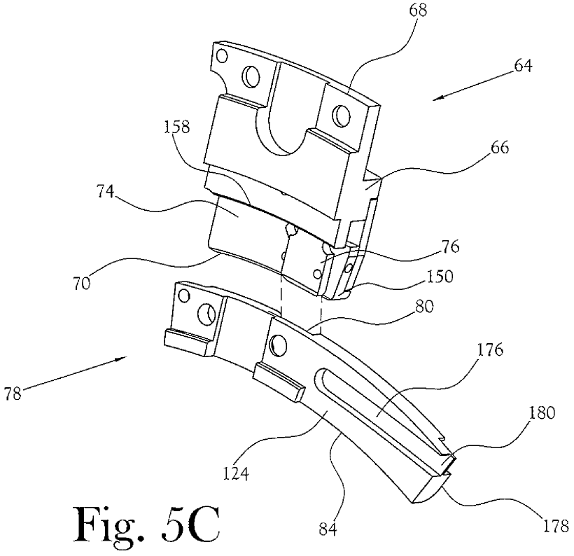

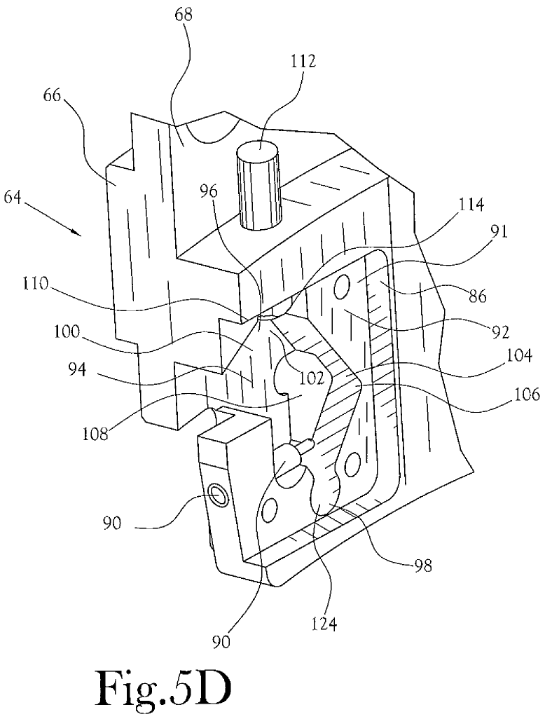

In the depicted embodiment of the latch 64 seen in FIGS. 1, 5B and 5C, there is mounted on the mounting ring 72 for the segments of the main deck, a receiver 78 having a dove tail-type groove 80 defined in the inboard surface 74 of the receiver for the snug sliding locking receipt therein of the projection 76 on the latch housing. In the depicted embodiment, this receiver comprises one end 82 of an elongated camming guide 84 mounted on the mounting ring 72 for the main deck. This receiver is disposed proximate the bottom end 70 of the latch housing. The dove tail groove 80 defined in that surface 74 thereof faces inwardly of the drum in position to receive the latch housing projection 76 within such groove 80. This structure and action anchors the latch housing, hence the central segment of a module, hence a module, rigidly with, but removably from, the mounting ring for the main deck. When such interconnection is attained the main deck movements are imparted to the modules of the secondary deck in a manner which causes the segments of the secondary deck to follow the movements of the segments of the main deck, but with the movement of the segments of the secondary deck being within a range of diameters, each diameter of which is larger than the largest obtainable diameter of the drum when employing only its original main deck.

Further, in the depicted embodiment, the receiver 78 for the latch 64 associated with the secondary deck module may also comprise an elongated camming guide 84 as will appear thereinafter.

It will further be noted that in the depicted embodiment of the present invention, each latch associated with each end of the central segment of each module employed in the present invention is a locking latch, and their respective receivers are substantially minor images on one another.

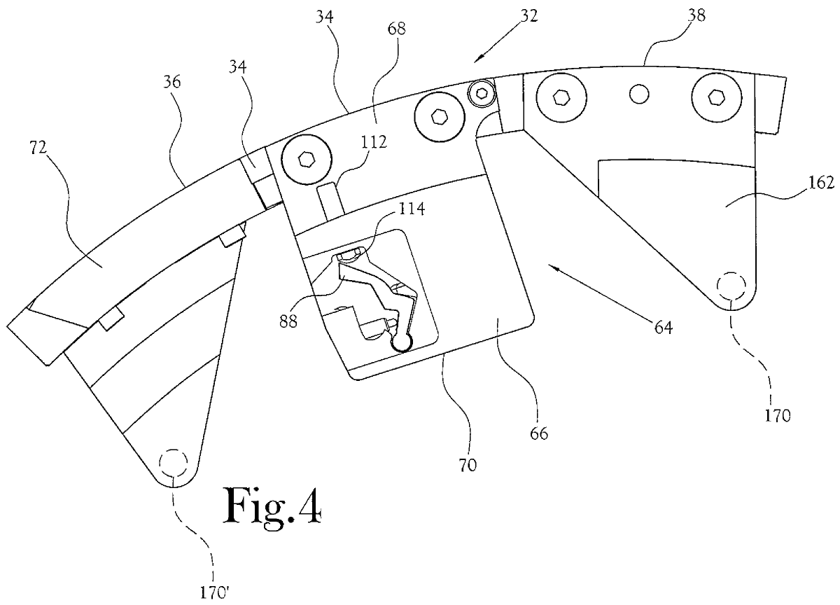

For releasably locking each of a plurality of modules on an existing drum having a main deck which is adjustable between maximum and minimum diameters, the latch of the present invention which is affixed to and extends radially inwardly of the central segment of a module of the present invention is of generally flat rectangular geometry and includes a latch compartment 86 (FIG. 5A) that houses a pivoting latching lever 88 (FIG. 4, 6 and 7) which is biased toward a latching position as by a spring-loaded plunger 90 embedded within the latch compartment. Unlatching of the latch lever is provided for by means of a release pin 112 (FIG. 5A) mounted in the latch compartment in position for its enlarged inboard end 114 to reside proximate the latching lever (FIG. 4) such that depression of this release pin against the latching lever may overcome the biasing force of the spring-loaded plunger 90 and move the latch to an unlatched position. This release pin is conveniently located on the latching housing so as to be accessible to the thumb of a user's hand for depression of the release pin when the module is grasped by a user's hands at the opposite ends of the central segment of a module. By this means, the latching lever may be moved into its unlatched position by the push pin for removal of the module from the drum.

Automatic latching of the latch housing to the receiver occurs when the projection on the latch housing is fully inserted into locking relationship with the groove in the receiver as noted above. As seen in FIGS. 4, 5A-5D the latch compartment 86 defined in the latch housing includes first and second two levels 92 and 94, respectively. The first level 92 of one embodiment of the cavity as seen in FIGS. 4-10 is substantially rectangular in outline and extends into the latch housing to a depth less than fully through the thickness of the latch housing, and preferably terminates about halfway through the thickness of the latch housing. The outline geometry of a second level 94 of the cavity is somewhat of an irregular diamond shape having vertical apices 96 and 98 disposed proximate the top and bottom of the first level of the cavity. Importantly, one lateral apex 104 of the second cavity is cutway fully through the thickness of the housing, such cutaway defining an indent 106 in the second level of the cavity and an opening 108 of generally tear drop geometry which extends fully through the thickness of the housing.

Within the top wall 100 of the first level of the cavity, there is mounted a vertically slidable release pin 112 having an enlarged inboard head 114 and which is biased toward its most vertical outward position wherein the head of the pin engages the top wall 1 10 of the first level of the cavity.

Further, within the outboard side wall 116 of the first level of the cavity there is provided a locking plunger 90 (FIG. 9) having a distal end 120 that extends into the first level of the cavity. This plunger is biased toward its horizontal most inwardly position toward the indent 106 in the opposite wall 116 of the first level of the cavity. Notably, this distal end of the plunger terminates short of such opposite wall of the first level of the cavity and in operative engagement with the latching lever 88.

The bottom apex 98 of the first level of the cavity opposite the apex 96 in which the release pin is located, defines a generally circular cutout 124 which opens inwardly of the first level of the cavity.

Referring initially to FIG. 5B which depicts the outboard side of the latch housing and of the receiver, the dove tail projection 76 on the housing is depicted in phantom and underlies the latch compartment defined in the outboard surface of the housing. Being so positioned, such projection may be slidably received within the mating dove tail groove 80 defined in the outboard surface of the receiver. Progressing to FIG. 5B, this interrelationship of the projection and groove is also depicted but from the inboard side of the latch housing. In FIG. 5B, there also is depicted the tear drop opening 108 defined through the second level of the cavity.

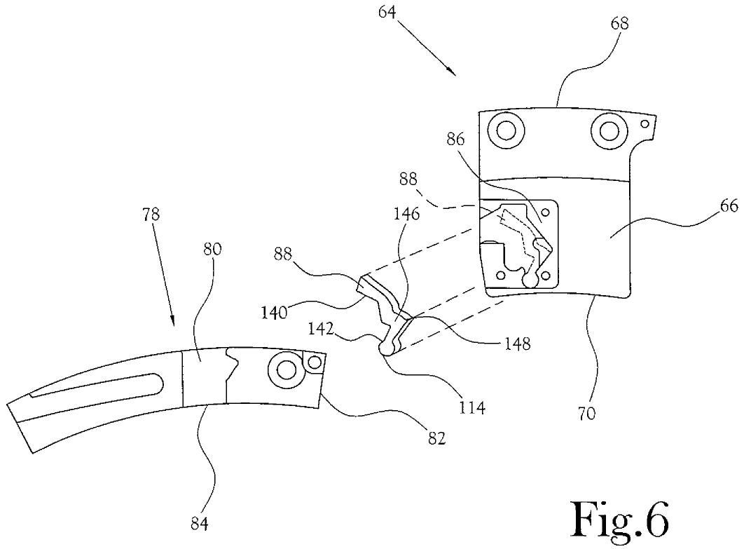

FIG. 6 also depicts an outboard side view of the latch and its receiver and a latching lever in exploded view. The depicted latch lever is of generally L-shape having first and second legs 140, 142, respectively. As depicted, the first leg 140 of this lever is contoured to be received within the top portion of the first level of the cavity and terminates proximate the release pin disposed in the top wall of the first level of the cavity. The second leg 142 of the lever includes a rounded distal end 114 which is adapted to be pivotably received within the circular cutout 124 at the bottom apex 98 of the first level of the cavity. When so positioned within the first level of the cavity, the midpoint joinder 146 of the legs of the lever defines an outboard lug 148 projecting therefrom which is at least partially disposed in alignment within at least a portion of the indent 106 defined in the side wall of the first level of the cavity. When so positioned, this lug on the lever further is accessible for engagement therewith by an inboard bottom corner 150 (FIG. 5C) of the projection as the projection enters the groove in the receiver in the course of joining the latch to the receiver.

As seen in FIG. 5B, the inboard side wall of the dove tail groove of the receiver has defined therein an indent 106 at a location proximate, but spaced inwardly of, the top wall 152 of the receiver. This positioning of the indent inwardly from the top wall of the receiver results in the development of a lug on the wall of the receiver at the junction of the indent and the top wall of the receiver. Accordingly, when the projection on the latch housing is introduced into the groove, such lug engages the lug 148 on the latching lever and serves as an actuator for opening the latch lever for the entry of the projection into the groove 80 in the receiver.

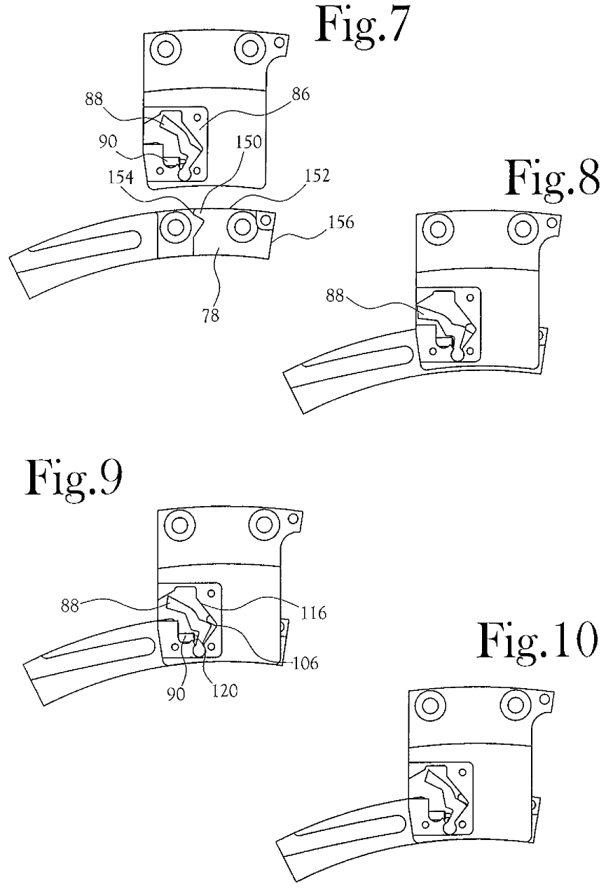

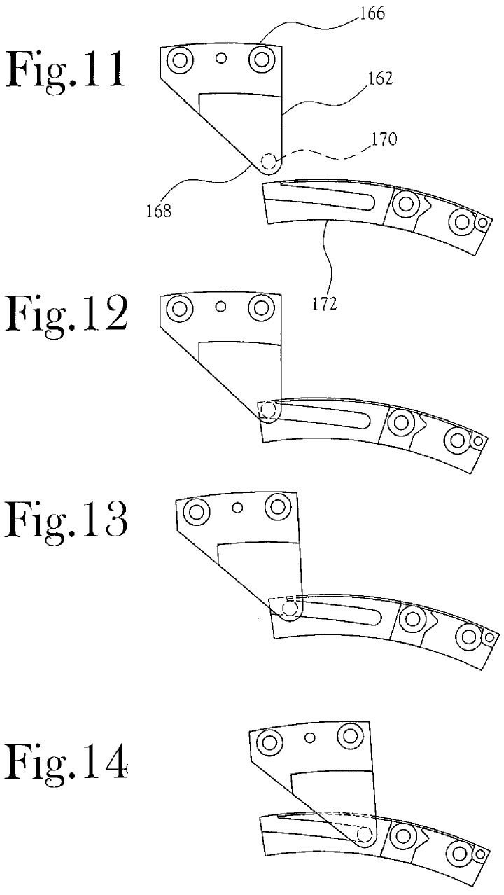

Referring to FIGS. 7-10, there is depicted in series, the action of engagement of the latch housing 66 with a receiver 78. In FIG. 7, the outboard end of the projection 76 on the latch housing 66 is depicted as poised for commencing entry of the projection into the groove 80 in the receiver. In FIG. 8, the progression of the insertion of the projection into the groove is progressed to the extent that the lug defined on the projection has entered the area of the tear drop opening 108 through the floor of the latch compartment cavity 91 and engaged the lug 148 defined at the joinder of the legs of the latching lever 88 thereby rotating the lever counterclockwise to permit the passage of the projection further into the groove.

In FIG. 9, the progression of the projection into the groove has advanced to the extent that the lug on the projection has moved partially past the lug on the lever, leaving the indent in the projection open. Thereupon, the latch lever commences rotation clockwise under the influence of the plunger mounted in the wall of the first level of the cavity, thereby causing the lug on the lever and portions of the legs of the lever, to commence entry into the indent in the wall of the projection.

Movement of the projection into the groove is halted by the top wall of the projection engaging a ledge 158 defined in the inboard surface of the housing in position to halt progression of the projection into the groove at a point wherein the lug on the latch lever, acting under the influence of the inwardly spring biased plunger bearing against the latch lever, fully enters into the indent in the wall of the groove and substantially rigidly locks the latch housing with the receiver, as seen in FIG. 10.

It will be recognized that since there is a latch associated with each of the opposite ends of the central segment of a module of the present invention, this locking action takes place substantially simultaneously at each of the opposite ends of the module when the module is being mounted on a drum

It will be recognized by one skilled in the art that the present latching feature permits one to mount readily replaceable segmented modules on a drum as an alternative to the fixedly mounting of a plurality of segments on a drum so that the modules define the “main deck of the drum. In this latter embodiment, the modules of the present invention define the only cylindrical working surface of the drum, but by reason of their ease of installation and removal, modules of differing sizes may be mounted directly to the radial positioning system of the drum to define different diameters for the cylindrical working surface of the drum.

As an adjunct to the latching of the central segment of a module of the present invention to a drum, there is further provided means for interconnecting each of the lateral segments of a module to the mounting ring of the drum.

In addition to the interconnection of the secondary deck to the mounting ring for the main deck of the drum by the latch, as depicted in the several Figures there is provided a radial guide 162 on at least one end 164 of the lateral segments of each module and on each of the opposite ends of the central segment of each module. Each such radial guide is generally planar and of a triangular geometry which viewed facing the plane of the radial guide. As seen in the FIG. 28, the base 166 of the triangular radial guide is affixed to the end 164 of its respective segment and depends radially inwardly in cantilevered fashion such that its apex 168 is disposed in overlying relationship to the mounting ring for the segments of the main deck. The apex of each radial guide is provided with a cam pin 170, which projects away from the plane of the radial guide inwardly of the drum.

On the mounting ring for the segments of the main deck of the drum there is provided a plurality of spaced apart elongated camming guides 172, there being one such guide member in radial alignment with a respective one of the radial guides spaced about the circumference of the mounting ring.

Each elongated camming guide includes a flat surface 124 (FIG. 5C) facing the main deck and in this flat surface there is provided an elongated open camming groove 176 extending along the length of the radial guide. This camming groove is oriented generally with the curvature of the mounting ring of the drum so as to be adapted to receive therein a cam pin projecting laterally outwardly from the apex of its respective radial guide. In the outboard end 178 of the camming groove, there is provided an open slot 180 through which the cam pin may move to enter into the camming groove in the course of mounting of the module on a existing drum, and to exit the camming groove in the course of dismounting the module from the drum. As seen in FIG. 3, on each module, there is provided a like, but mirror image, radial guide on each of the first and second ends of the central segment of each module. The radial guide and the interconnection of their respective pins provide for simultaneous and equal movement of the first and second segments with the radial movements of the central segment of the module. Inasmuch as all the segments of the secondary deck are interconnected with the mounting ring of the drum, all of the segments of the secondary deck are moved in unison with one another by the existing operational infrastructure of the drum and its main deck. No modification of such operational infrastructure of the drum is required for powering of movement of the components of the secondary deck of the present invention. Moreover, the interconnection of the lateral segments of each module of the present invention with the mounting ring for the segments of the main deck ensures simultaneous and like movement of each of the segments of all the modules of the secondary deck when the drum adjusts the diameter of the cylindrical working surface of the drum.

The extent of separation of the mounted secondary deck from the main deck is determined by the separation distance of the mounting location of the latch housing on the central segment of the module, and the distal end of the latch housing. As noted, this separation positions the secondary deck apart from the main deck by a distance sufficient for the segments of the secondary deck to be moved radially inwardly and outwardly for adjusting the diameter of the drum as desired, unimpeded by the presence of the multiple modules which define the secondary deck. By reason of the disposition of the second deck radially outward of the main deck, the drum is provided with the means whereby the range of obtainable minimum and maximum diameters of the drum is greater than the range of obtainable minimum and maximum diameters of the drum employing only the main deck.

To mount a module of the present invention on a drum, the module is grasped at its opposite ends by the user's hands. The module is oriented with respect to the drum so that the dove tail projections on the latch housing at the opposite ends of the central segment are aligned with the dove tail grooves on the receivers mounted on the drum and that the radial guides on the ends of each of the lateral segments of the module are aligned with corresponding camming grooves of respective ones of the receivers. Thereupon, the module is pushed generally radially into its mounting engagement with the drum. Such pushing action further functions to cause the dove tail projection of the latch to initially move past the biased locking lever. Further insertion of the latch housing into engagement with their associated receiver permits the latching lever to return to its latching position, hence its interlocking relationship with the dove tail projection. Removal of a module from the drum is accomplished by depressing the release pin to move the latching lever to its unlocked position, whereupon the module may readily be withdrawn from the drum.

Whereas the present device is depicted as being useful with a drum of the type disclosed in the “016 patent”, it will be recognized by one skilled in the art that the present invention is applicable to a transfer ring-type device (also disclosed in the “016 patent”) wherein the need is to enhance the range of obtainable diameters of the transfer ring, as opposed to enhancing the range of enhancing the range of obtainable diameters of a belt and tread drum. In either device, the modules of the present invention are mountable on the an existing device.

What is claimed is:

1. Apparatus for establishing a range of obtainable diameters of a drum having a cylindrical working surface defined by a plurality of elongated segments mounted on first and second mounting rings disposed on opposite sides of the drum, and extending around the drum, and including means for radially inward and outward movement of the segments for decreasing or increasing the diameter of the cylindrical working surface within the range comprising
a plurality of individual modules releasably mounted around the drum at spaced apart locations along the mounting rings of the drum and extending radially outwardly of the mounting rings to collectively define a cylindrical working surface of the drum,
each module comprising a central elongated segment and first and second lateral segments having respective elongated sides hingedly affixed to respective elongated sides of said central elongated segment, said segments collectively defined a portion of a cylindrical working surface for the drum;
first and second locking latches mounted on respective opposite ends of said elongated central segment;
respective receivers mounted on the mounting ring at spaced apart locations around the circumference of the mounting ring;
each of said locking latches including respective ones of a first component and a mating second component, said first component and said second mating component being adapted to releasably engage one another to lockingly latch the respective first and second components to one another.

2. The apparatus of claim 1 wherein said first component comprises an elongated projection and said second component comprises an elongated groove adapted to snugly receive therein said projection.

3. The apparatus of claim 2 wherein said elongated groove includes a first inside a wall having an indent defined therein.

4. The apparatus of claim 3 and including a latch compartment defined in said latch housing, said latch compartment including latch lever receiprocatably mounted within said latch compartment, said latch lever being rotationally biased toward engagement with said indent in said wall of said first component when said first and second components are in registered matingly joined relationship with one another.

5. The apparatus of claim 4 and including a release pin mounted in said housing compartment in position to engage said lever latch and provide for user application of a force against said lever latch sufficient to produce disengagement of said lever latch with said indent.

6. The apparatus of claim 1 wherein said drum is adapted to provide for radial extension and retraction of said modules for selection of the diameter of said cylindrical working surface of the drum collectively defined by said plurality of modules, and each of said receivers is adapted to be mounted on the drum in position for interconnection of said modules with said radial extension and retraction.

7. The apparatus of claim 1 and including at least one radial guide interconnecting each of said lateral segments with said mounting ring of the drum.

8. The apparatus of claim 7 wherein each of said radial guides includes a distal end which extends in substantially cantilevered fashion from its respective lateral segment and into overlying relationship to a respective one of said receivers, a cam pin disposed in said distal end of each of said radial guides, and wherein each receiver underlying a radial guide defines a camming groove aligned generally with said mounting ring, said camming groove providing for entry of said cam pin into said groove when said module is being mounted on the drum and during subsequent operation of the drum, and for existing said camming groove when said module is being dismounted from the drum.

9. The apparatus of claim 1 and including spring means associated with said module for biasing said lateral segments toward respective preselected rotational positions relative to their hinged mounting to said central module whereby said module may be manually manipulated as a unit without material hinged movement of said lateral segments relative to said central segment in the course of mounting of said module on the drum or dismounting of said module from the drum.

10. A method for establishing a cylindrical working surface on a drum comprising the steps of
a. providing a plurality of modules, each comprising a central elongated segment and first and second lateral segments hingedly mounted on respective opposite sides of said central segment, said lateral segments being biased against rotation of said lateral segments relative to said central segment in the absence of an external rotational force being applied to said lateral segments whereby said module may be handled and manipulated as a unit,
b. manually releasably mounting each of said plurality of modules on the drum about the circumference of the drum in positions wherein said modules collectively define a cylindrical working surface for the drum.

11. The method of claim 10 and including the step of manually releasably interlocking said modules to the drum.

12. The method of claim 11 wherein each of said modules includes a latch affixed to opposite ends of said central segment of the module and including the steps of providing respective receivers spaced apart about the circumference of the drum and aligning said modules with respective ones of said receivers and manually effecting releasable joinder of said latch with said respective ones of said receivers.

13. The method of claim 10 wherein each of said segments is of a substantially arcuate cross section.

14. A latch useful for manually mounting each of a plurality of modules about the circumference of a drum whereby said modules collectively define a working surface for the drum, said latch including a latch housing of generally planar geometry and having an inboard and an outboard surface, a top end and an opposite bottom end, said top end of said latch housing being adapted to be mounted on an end of a module in position for said latch housing to extend in cantilevered fashion in overlying relationship to a receiver mounted on the drum, a latching compartment defined in said outboard surface of said latch housing, said latching compartment housing therein a latching lever having a first end thereof reciprocatably mounted within said latching compartment and defining a lug thereon, an opening defined in said latching compartment through the thickness thereof whereby said lug of said latching lever is accessible from said inboard surface of said latch housing, said receiver including an indent defined in a said wall thereof, said indent being in register with said opening through said compartment housing when said latch housing is fully engaged with said receiver, thereby providing for entry of said lug into said indent for releasable lockingly joining said latch housing with said receiver, hence releasably joinder of said module module to the drum.

15. The latch of claim 14 wherein said latch lever is biased toward engagement of said lug with said indent.

16. The latch of claim 15 and including a manually manipulatable release pin extending from external of said latching compartment and internal of said latching compartment, said release including a distal end thereof disposed within said latching compartment and in position to engage said latching lever for application of a counter rotation of said latching lever for effecting withdrawal of said lug from said indent, hence unlocking the joinder of said latch housing from said receiver, upon a user applying a linear force to said release pin.
